(19) United States
(12) Patent Application Publication
(10) Pub. No.: US 2008/0068998 A1
(43) Pub. Date: Mar. 20, 2008

(54) REDUCING LATENCY ASSOCIATED WITH INITIATING REAL-TIME INTERNET COMMUNICATIONS

(75) Inventors: MOHIT JAGGI, Sunnyvale, CA (US); Alak K. Deb, San Jose, CA (US)

Correspondence Address: MARTINE PENILLA & GENCARELLA, LLP, 710 LAKEWAY DRIVE, SUITE 200, SUNNYVALE, CA, 94085, US

(73) Assignee: XAMBALA CORPORATION, San Jose, CA (US)

(21) Appl. No.: 11/852,202

(22) Filed: Sep. 7, 2007

Related U.S. Application Data
(60) Provisional application No. 60/825,097, filed on Sep. 8, 2006.

(51) Int. Cl. H04L 12/56

(52) U.S. Cl. 370/232

(57) ABSTRACT

A switch including circuitry and methods for decreasing latency associated with initiating Internet communications are disclosed. The switch includes a host processor and a transport subsystem that receives incoming data and sends outgoing data. The switch also has a semantic processor. The semantic processor anticipates real-time communication by analyzing the incoming data for specific types of data from a first user in order to instruct the host processor to pre-fetch data needed to initiate real-time communications with a second user. The pre-fetching of the data needed to initiate real-time communications decreases the latency associated with establishing communications between the first user and the second user.

### CLAIM OF PRIORITY

The present application claims priority from U.S. Provisional Application No. 60/825,097, filed on Sep. 8, 2006, which is herein incorporated by reference.

### BACKGROUND OF THE INVENTION

1. Field of the Invention

The present invention relates generally to improving communications that use Internet based routing.

2. Description of the Related Art

The variety of methods available to telecommunicate continues to grow. Phone calls, emails, push to talk, video chat, voice over internet protocol (VoIP), short message service (SMS), and instant messaging can all be conducted from a variety of hardware. Before the adoption of VoIP there was a general division between voice and data networks. Voice communications were generally left to telephones both wired and wireless while text and data based communications were generally the province of computers and devices capable of connecting to the Internet.

The continuing deployment of advanced wireless networks and multifunction wireless devices in conjunction with the continuing adoption of broadband Internet access is providing a convergence of voice and data networks. Mobile devices are capable of handling voice calls, email, text messaging, SMS, and web browsing. VoIP continues to allow voice communications between users of computers connected to the Internet. Additionally, telephone calls between packet switching VoIP phones and the circuit switching public switched telephone network are becoming commonplace.

However, inherent in any form of communications using packet switching is latency. Latency can be particularly frustrating when it impacts the ability to initiate real time communications such as instant messaging or a VoIP telephone call. In view of the forgoing, there is a need to decrease the latency associated with initiating and conducting communications between parties across the Internet.

### SUMMARY

In one embodiment, a switch for decreasing latency associated with initiating Internet communications is disclosed. The switch including a host processor and a transport subsystem that receives incoming data and sends outgoing data. The switch also has a semantic processor. The semantic processor anticipates real-time communication by analyzing the incoming data for specific types of data from a first user in order to instruct the host processor to pre-fetch data needed to initiate real-time communications with a second user. The pre-fetching of the data needed to initiate real-time communications decreases the latency associated with establishing communications between the first user and the second user.

In another embodiment, a method for decreasing the latency associated with initiating real-time Internet communications is disclosed. The method comprising analyzing incoming data to a transport subsystem of an Internet switch and determining whether the incoming data contains data relevant to initiating real-time communications with a second party. If the incoming traffic contains data relevant to initiating real-time communications, the method further including requesting a host processor of the Internet switch to query a database to pre-fetch data needed to establishing real-time communication with the second party. The method further includes storing the data associated with the second party in a cache associated with the Internet switch. Wherein latency is reduced when initiating a real-time communication to the second party, as the data associated with the second party is stored within the cache.

Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings.

FIG. 1 is a schematic showing various types of hardware capable of real-time communications using the Internet, in accordance with one embodiment of the present invention.

FIG. 2 is a diagram illustrating traffic on the Internet, in accordance with one embodiment of the present invention.

FIG. 3 is a simplified schematic diagram illustrating a high-level architecture of the SPU system found in a switch, in accordance with one embodiment of the present invention.

FIG. 4 is a diagram illustrating the processing conducted by the SPU, in accordance with one embodiment of the present invention.

FIG. 5 is a diagram illustrating a sample of the types of packet switching real-time communications that can benefit from decreased latency, in accordance with one embodiment of the present invention.

FIGS. 6A-6D are diagrams illustrating the operations between accessing information in the phone book and the SPU system, in accordance with one embodiment of the present invention.

FIGS. 7A-7C are illustrations of data flow in a SPU system, in accordance with one embodiment of the present invention.

FIG. 8 is a flowchart illustrating the procedure for using an SPU system, in accordance with one embodiment of the present invention.

### DETAILED DESCRIPTION

An invention is disclosed for reducing latency associated with initiating real-time communications over the Internet. In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

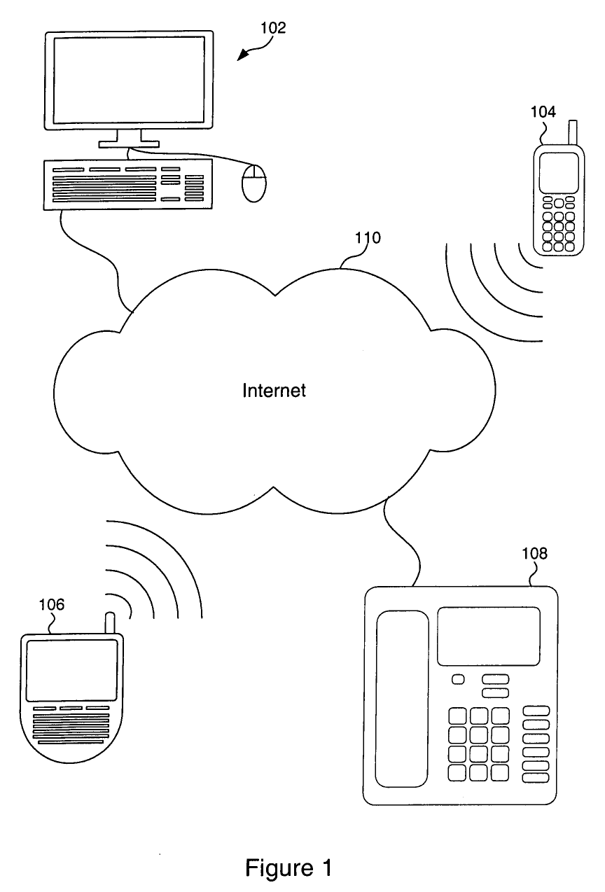

FIG. 1 is a schematic showing various types of hardware capable of real-time communications using the Internet. 1 10 in accordance with one embodiment of the present invention. A computer 102, or a Voice over Internet Protocol (VoIP) phone 108 can be connected to the Internet 110 using multiple methods including, but not limited to, broadband technologies such as a asymmetric or symmetric digital subscriber line (ADSL/SDSL), cable modem, fiber optic or satellite Internet. The computer 102 can be of a variety of form factors including a desktop, notebook, tablet, ultra mobile, or small form factor. Regardless of form factor, the computer 102 may include a central processing unit, memory and mass storage. It is also possible to connect the computer 102 or VoIP phone 108 to the Internet 110 using wireless technologies such as those outlined in the Institute of Electrical and Electronics Engineers (IEEE) 802.x standard. The specific examples provided above are not intended to be restrictive but rather illustrative. It is intended that the disclosed embodiment will be compatible with future standards of wired and wireless Internet access.

Internet enabled wireless devices such as a cellular phone 104 or a smart phone 106 can initiate real-time communications using cellular phone and data standards such as General Packet Radio Service (GPRS), the various implementations of Code Division Multiple Access 2000 (CDMA2000), Enhanced Data rates for GSM Evolution (EDGE), Wideband Code Division Multiple Access (W-CDMA), and High Speed Downlink Packet Access (HSDPA). It is also possible for the cell phone 104 or the smart phone 106 to be able to access the Internet 110 using the previously discussed IEEE 802.x standard. Similarly, it is possible that the computer 102 or VoIP phone 108 is enabled to use the previously discussed cellular phone and data standards. The listing of cellular phone wireless standards is not inclusive of all of the technologies available to wirelessly access the Internet 110. The list provided is meant to be exemplary and it should be understood that it is intended for the disclosed invention to be compatible with future cellular phone and data standards.

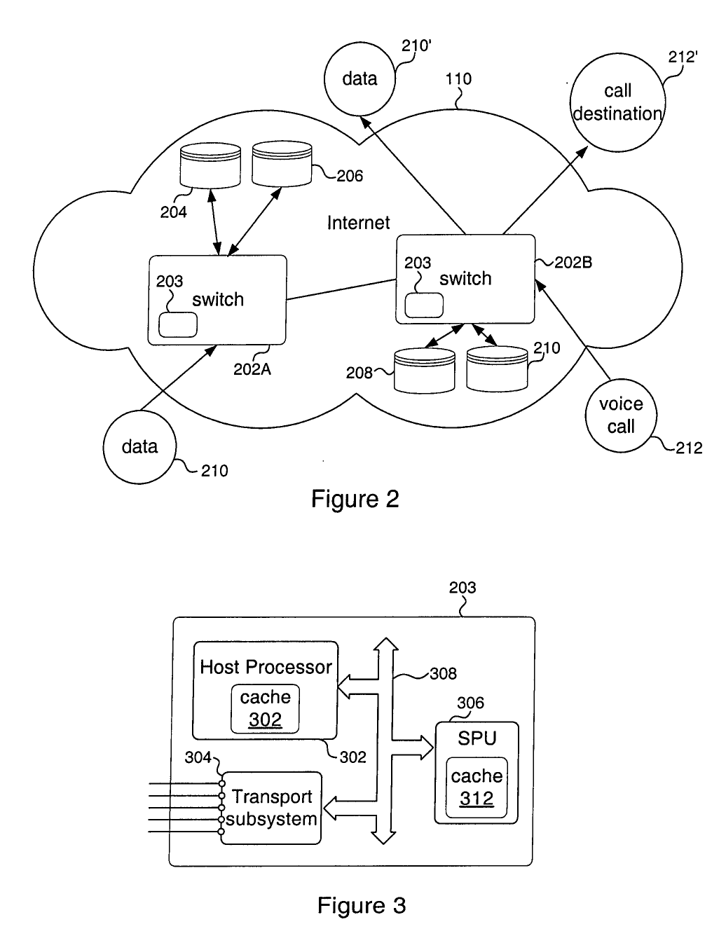

FIG. 2 is a diagram illustrating traffic on the Internet 110 in accordance with one embodiment of the present invention. The Internet 110 is shown as incorporating a switch 202A and a switch 202B. It should be clear to a person skilled in the art that the diagram illustrates that the switches are connected to the Internet 110 and provide the necessary packet switching. Only two switches are shown in the diagram for clarity and it should be understood that an unlimited number of switches could be used in the access of the Internet. The switch 202A can communicate with a database 204 and a database 206. The switch 202B can communicate with a database 208 and a database 210. In this simplified depiction of the Internet 110 the databases represent all data accessible using the Internet 110. In one embodiment the switch 202A may be able to access the database 208 and the database 210 using the Internet 110. In another embodiment only specific switches may have access to particular databases.

Broadly defined, the term “packet switching” should encompass any number of switching operations that require analysis of packets or data units. Generally speaking, packets can be in the form of standard units used in any number of communication environments, such as the general Internet, local and wide-area Ethernets, optical transmissions, phone equipment and protocols, call switching, datagram switching, forwarding, passing, storage, and any associated examination or processing. For ease of understanding and without limitation, however, the following discussion will be presented with regard to packet switching. In a specific example, packet switching could be considered call switching, as it relates to voice communications over a network (e.g., the Internet).

In FIG. 2, data 210 from one client is shown entering the switch 202A and exiting from the switch 202B to another client as data 210′. Similarly a voice call 212 from one client is shown entering the switch 202B while a call destination 212′ for a second client is also shown connected to the switch 202B. The switch 202A and the switch 202B also contain a semantic processing unit (SPU) system 203 that will be discussed below.

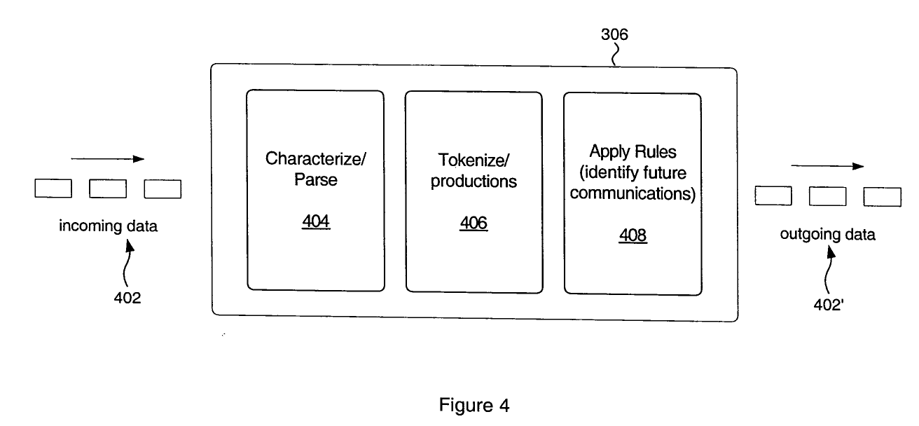

FIG. 3 is a simplified schematic diagram illustrating a high-level architecture of the SPU system 203 implemented in a switch in accordance with one embodiment of the present invention. The SPU system 203 includes a host processor 302, a transport subsystem 304 and a SPU 306. The host processor 302 has a host processor cache 310 and communicates with the transport subsystem 304 and the SPU 306 using a bus 308. The bus 308 may in fact be several separate address, data and control lines but are shown generally as an arrow. The transport subsystem 304 handles communications between at least two clients using the Internet. The transport subsystem 304 can incorporate network-processing units (NPUs), TCP offload engines (TOE), secure socket layer (SSL) accelerators and other hardware and software designed to facilitate transporting data using the Internet.

The SPU 306 contains an SPU cache 312 and is designed to work in conjunction with the host processor 302 and the transport subsystem 304. The SPU 306 simultaneously collates segments for a specific connection in network streams carried over multiple packets and parses and processes the actual message in order to understand the meanings associated with the message. The ability to understand the meaning of the message is, in one embodiment, enabled through grammar based parsing in conjunction with grammar based analysis.

Although mention is made regarding “grammar”, the analysis should be broadly construed to include any type of data analysis, and the data can be in the form of streaming data traveling over a network. The data analysis can be defined to impart varying degrees of analysis/processing on the data or group of data, as it travels along a network path. The analysis can be performed on hardware that sits on the network (e.g., routers, hubs, network interface cards, servers, computers) or can be processed at specific end-points along a network connection. In one example, if the analysis is more stringent, the analysis may employ different types of algorithms that can be processed on one or more processor chips/memories or application specific chips and cache memories, depending on what the analysis is targeted to find or identify from a stream of data traveling over the network. For ease of understanding, reference will be made to one type of analysis, which may be grammar based.

With the above definition in mind, grammar based parsing defines tokens associated with the segments of a message, while grammar based analysis enables the determination and application of rules corresponding to each of the tokens. The ability to understand the meaning of the messages associated with packet-based networks enables fast searching that can detect specific types of data. In one embodiment, the fast examination of the packet data is conducted while the data is in transit through the switch and is performed without impacting network speed.

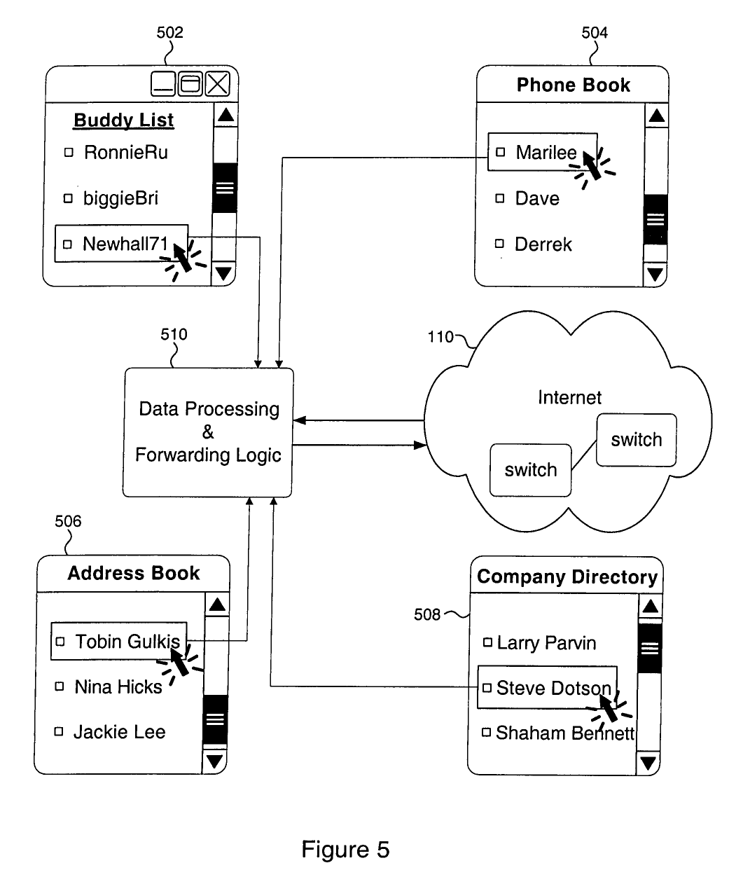

FIG. 4 is a diagram illustrating the processing conducted by the SPU 306 in accordance with one embodiment of the present invention. An incoming data stream 402 is initially characterized and parsed in block 404 while in transit through the switch at full network speed. Continuing to move at full network speed, after the data has been characterized and parsed the data is tokenized based on the type of information contained in the message. Still traversing the switch at full network speed, Block 408 applies rules to the tokenized data. The applied rules are designed to search for indications of potential real-time communications without impeding the flow of data through the switch. In one embodiment, one of the many applied rules that indicate potential real-time communication is the detection of a session initiation protocols (SIP) uniform resource identifiers (URI). If the SPU 306 detects a SIP URI the SPU 306 can instruct the host processor to query the proper remote database to pre-fetch the information necessary to resolve the real-time communication that is likely to happen in the near future, as may be extended in accordance with the teachings provided herein.

For example, in one embodiment, when a user loads a phone book stored on a remote server the SPU 306 would process and analyze the incoming data based on the applied rules as the data is passed through the switch at full network speed. In this one embodiment the SPU 306 recognizes the loading of a remotely stored phone book as something indicative of potential real-time communications. The SPU 306 can request that the host processor pre-fetch the information necessary to initiate a conversation with the default phone numbers for the people listed in the remotely stored phone book. In another embodiment the loading of an instant messaging buddy list can prompt the SPU to request the pre-fetching of data needed to conduct an instant message conversation. In yet another embodiment the SPU can identify the loading of a push-to-talk over cellular (PoC) contact list as a precursor to real-time communication and request the pre-fetching of data needed to initiate the conversation. In another embodiment the SPU can search for, identify, and instruct the host processor to pre-fetch data associated with call addresses or other forms of real-time communications embedded within web pages. The embodiments should not be considered limited to solely to the listed communications methods.

It should be understood that any package switching real-time communications protocol that sends data identifiable as a precursor to real-time communications through an internet switch contact list from a remote server could benefit from the reduced latency provided by the SPU system 203. For more information regarding example SPU systems, reference may be made to co-owned U.S. Applications: (1) application Ser. No. 11/348,827, entitled HARDWARE THREAD CONTROLLER WITH APPLICATION TO EMBEDDED PROCESSORS, filed on Feb. 6, 2006, (2) application Ser. No. 11/372,630, entitled PIPELINE SEMANTIC PARSER, filed on Mar. 9, 2006, (3) application Ser. No. 11/373,715, entitled STREAMING PIPELINED LEXICAL ANALYZER, filed on Mar. 10, 2006, (4) application Ser. No. 11/375,385, entitled METHOD AND SYSTEM FOR MANAGING DATA FLOW IN A PARALLEL PROCESSING SYSTEM, filed on Mar. 13, 2006, (5) application Ser. No. 11/374,927, entitled METHOD AND SYSTEM FOR DATA FLOW DRIVEN PARALLEL PROCESSING SYSTEM filed on, Mar. 13, 2006 and (6) application Ser. No. 11/373,729, entitled METHODS AND SYSTEMS FOR PREPROCESSING STREAMING DATA TO PERFORM DATA THINNING BEFORE PROCESSING OF THE STREAMING DATA, filed on, Mar. 10, 2006, each of which is incorporated by reference herein.

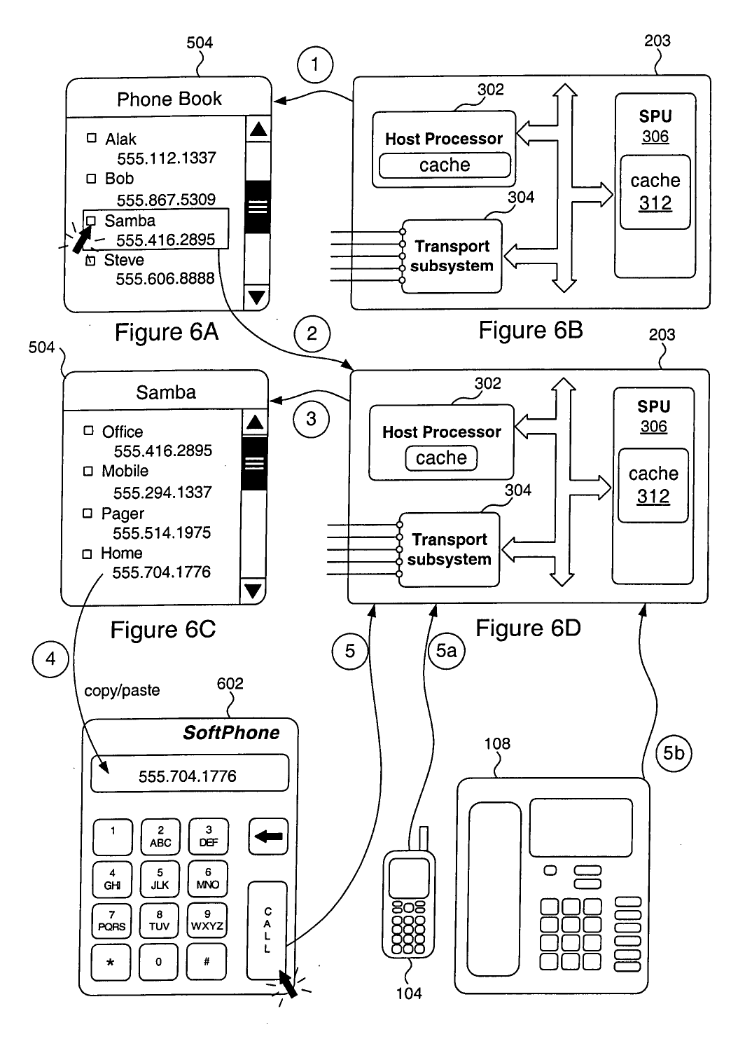

FIG. 5 is a diagram illustrating a sample of the types of packet switching real-time communications that can benefit from decreased latency in accordance with one embodiment of the present invention. A buddy list 502 indicates the use of an instant messaging protocol while a phone book 504 can be found in conjunction with a push to talk over cellular system. An address book 506 and a company directory 508 illustrate initiating VoIP calls from an electronic address book or an Internet protocol private branch exchange (IP PBX). In each case, the respective communications system is connected to data processing and forwarding logic 510.

The data processing and forwarding logic 510 is able to provide two-way communications with the Internet 110. Once the communication from the devices reaches the Internet 110 the communications can be routed to the intended recipient. In one embodiment the data processing and forwarding logic 510 is built into each device. In another embodiment the data processing and forwarding logic 510 may be separate from the device and shared among multiple non-homogenous devices. For example, a company may keep a unified address book 506 and company directory 508. However, the address book may only be accessible using the company email interface while the company directory may only be accessible through a telephone connected to the company private branch exchange.

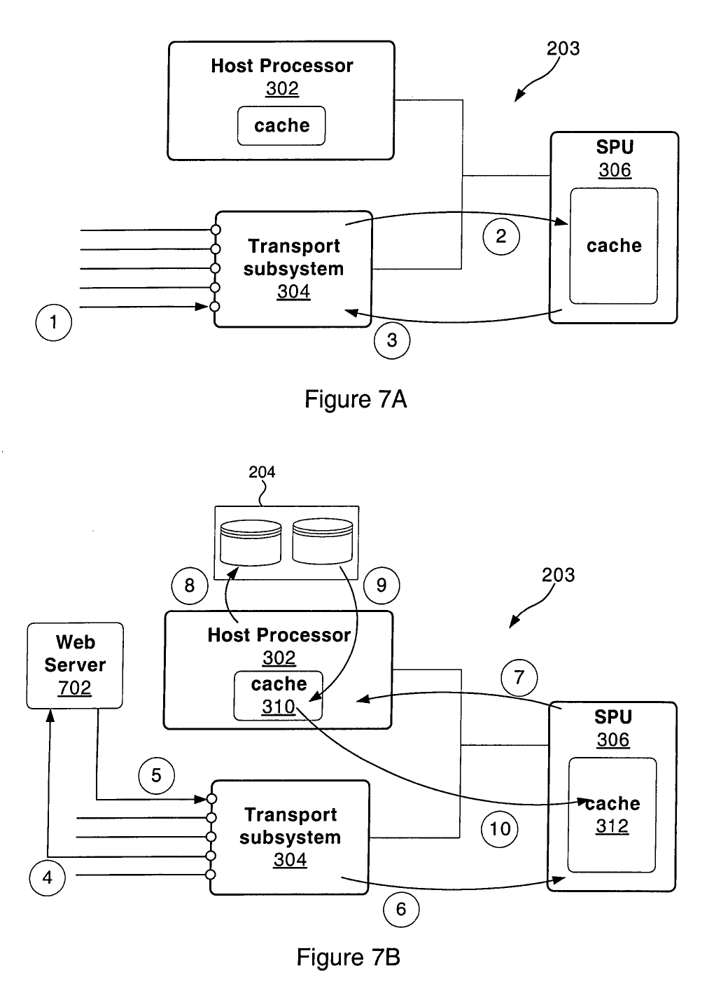

FIGS. 6A-6D are diagrams illustrating the operations between accessing information in the phone book 504 and the SPU system 203 in accordance with one embodiment of the present invention. FIG. 6A shows that the phone book 504 has been loaded from the SPU system 203 using operation 1. FIG. 6B shows the state of the SPU system 203 after accessing the database storing the phone book data and passing the data to be displayed in the phone book 504. In FIG. 6B, the SPU 306 has detected the potential for real-time communications associated with loading the data for the phone book. The SPU 306 requested the host processor 302 to query the appropriate database and pre-fetch data needed to initiate a real-time communication with the people listed in the phone book. The data needed to initiate a real-time communication returned by the database is stored in the SPU cache 312.

Operation 2 illustrates the result of a user selecting Samba from the phone book 504 from FIG. 6A. In this embodiment, selecting Samba from the phone book 504 results in a query to the database storing the phone book data for additional contact information for Samba. As the request passes through the switch with the SPU system 203, the SPU 306 processes and analyzes the request for the additional contact information for Samba as a potential precursor to communications. While passing the request for Samba's additional contact information to the appropriate database the SPU 306 makes a request to the host processor 302 to retrieve the data necessary to initiate communications with Samba. After the host processor retrieves the data necessary to initiate communications with Samba the data can be temporarily stored in the SPU cache 312.

Operation 3 results in the phone book 504 in FIG. 6C displaying the additional contact information for Samba which includes multiple phone numbers. In one embodiment the SPU cache 312 now contains the data needed to initiate real-time communications for all of the phone numbers for Samba. In another embodiment, the SPU cache 312 contains the data needed to initiate real-time communications for all of Samba's phone numbers and the default phone numbers for all the names stored in the phone book. The capacity of the SPU cache 312 can be determinative of how much data needed to initiate real-time communications can be stored.

Operation 4 shows the home phone number for Samba being copied and pasted into a soft phone computer application 602. This would be necessary if the phone book 504 did not have an integrate telephone service and required the use of a software based VoIP program or an external VoIP phone. Alternatively, if there was an integrated telephone service, operation 4 may not be necessary and a call to any of Samba's telephone numbers could be initiated by selecting the desired number.

Operation 5 shows the user of the soft phone computer application 602 choosing to call the home phone number for Samba. Alternatively, operation 5a is the result of dialing one of Samba's phone numbers from a mobile phone 104 while operation 5b shows of dialing one of Samba's phone numbers from a desktop VoIP phone 108. Regardless of what type of device initiates the call, the latency of initiating the call can be reduced as long as the request to initiate the call to Samba passes through the switch with the SPU 306. The latency can be reduced because the relevant information necessary to initiate the call may already be stored in the SPU cache 312.

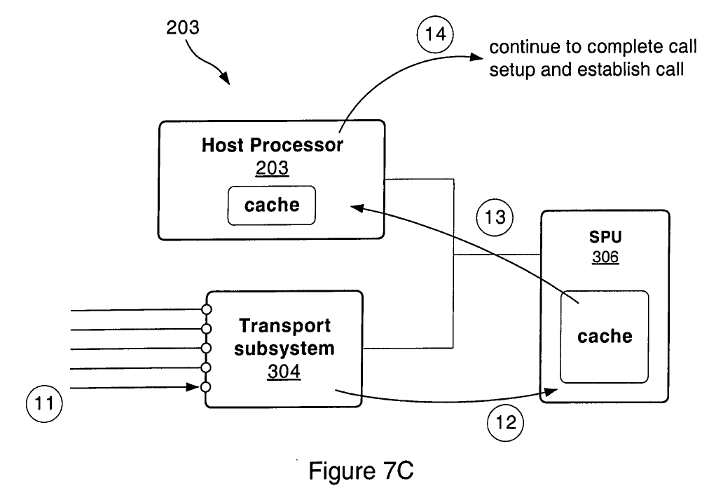

FIGS. 7A-7C are illustrations of data flow in a SPU system 203 in accordance with one embodiment of the present invention. Operation 1 shows data from a user entering the transport subsystem and, in operation 2, being processed by the SPU 306. In one embodiment the data sent through the switch in FIG. 7A can be a request to a web sever for phone book data. In another embodiment the data can be a request to a remote server to load a buddy list for an instant messaging program. Note that operation 2 is conducted while the data is in transit through the switch and does not slow the flow of data through the switch. Continuing with FIG. 7A, the SPU 306, not having found data requiring further action passes the data back to the transport subsystem as shown in operation 3.

In FIG. 7B operation 4 is the request for data from FIG. 7A being passed to a web server 702. The web server 702 sends the requested data back to the user through the switch and transport subsystem 304 as shown in operation 5. Though not shown, the data from the web server 702 sent in operation 5 is forwarded to the user. Operation 6 shows the transport subsystem 304 passing the data to the SPU 306 for processing and analysis. The SPU 306 detects potential communications in the data the web server 702 is returning to the user. Operation 7 is a request from the SPU 306 to the host processor 302 to pre-fetch the relevant data necessary to establish the appropriate type of communications.

Operation 8 illustrates the host processor making a request to a database 204 for relevant data necessary to establish communications. Operation 9 illustrates the database 204 returning the data relevant to establishing communications. In one embodiment the host processor 302 makes the request to the database 204 using the transport subsystem 304 because the database 204 is maintained in a remote location. In another embodiment a host processor 302 can query the database 204 using a dedicated connection to the Internet not associated with the transport subsystem 304.

In one embodiment operation 9 temporarily stores the pre-fetched data from the database 204 in the host processor cache 310 before completing operation 10 that sends the data to the SPU cache 312. In another embodiment the data returned in operation 9 is immediately sent to the SPU cache 312. The pre-fetched data is stored in the SPU cache 312 until a request to initiate the predicted communications is received or the data is supplanted by newer data.

In FIG. 7C operation 11 shows that data from the user entering the transport subsystem 304. In this instance the user wishes to initiate a real-time communication with a second user. Operation 12 shows the data requesting the initiation of a real-time communication being passed to the SPU 306 for processing. The SPU 306 conducts real-time processing and determines that the information necessary to initiate communications with the second user is stored within the SPU cache 312. Operation 13 indicates that the SPU 306 passes the cached information to the host processor 302. Then, the host processor 302 executes operation 14 where the host processor 302 continues to setup the communications and the communications are established.

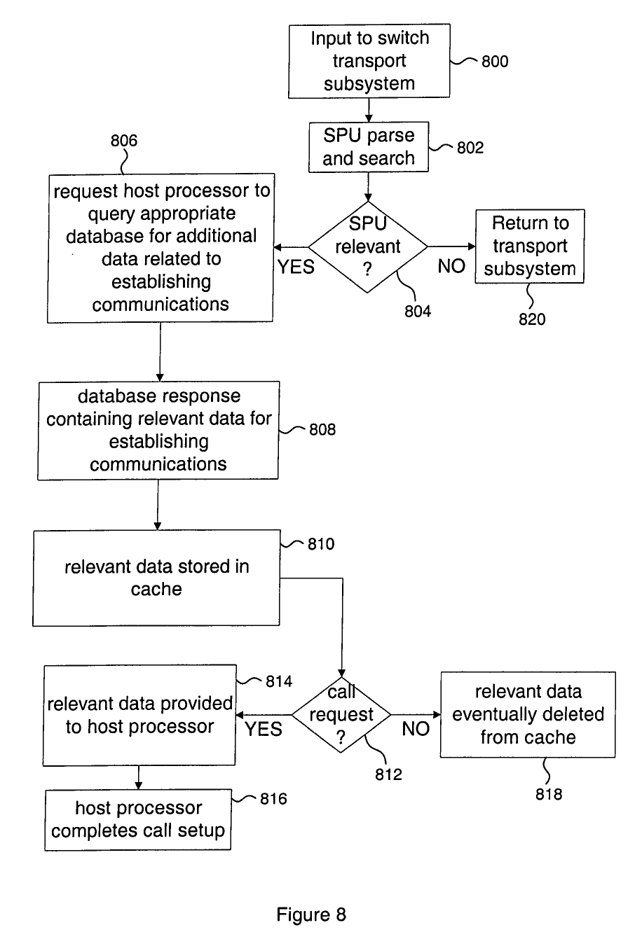

FIG. 8 is a flowchart illustrating the procedure for using an SPU system in accordance with one embodiment of the claimed invention. The procedure begins with operation 800 where packet data input to a switch transport subsystem is received. The transport subsystem is capable of receiving and sending packet data associated with the Internet and the switch contains a SPU system. The SPU system contains an SPU that, as shown in operation 802, parses, tokenizes and searches the packet data for information relevant to a set of defined rules. Operation 804 is where the SPU determines if the data contains information relevant to the set of defined rules. For example, the defined rules can instruct he SPU to look for session initiations protocol uniform resource identifiers or other data indicative of establishing real-time communications.

If the SPU finds data conforming to the defined rules, the procedure continues with operation 806. Operation 806 is a request from the SPU to the host processor to pre-fetch data needed to initiate real-time communications with a second party. The host processor may need to query a database to retrieve the necessary information. In one embodiment the request can be to retrieve relevant information regarding a single contact. In another embodiment the request can retrieve relevant information for a group of contacts. Operation 808 is the response from the database. The host processor sends the relevant information from the response to the SPU where the relevant information is stored in the SPU cache as indicated by operation 810.

Operation 812 determines if a request to initiate the predicted real-time communications is received by the switch. If the request to establish real-time communications is made, operation 814 provides the data stored in the SPU cache to the host processor. This is followed by operation 816 where the host processor completes the setup and establishes the requested communications. If the request to initiate the predicted communications is not received by the switch operation 818 may eventually delete the cached data in the SPU. In one embodiment the data stored in the SPU cache will be deleted after a specified period of time. Alternatively, the data stored in the SPU cache can be deleted on a first-in-first-out basis depending on the size and data flow of the cache. If operation 814 determines that the incoming data is not relevant to establishing communications based on the user-defined rules the procedure continues to operation 820. Operation 820 allows the data to continue back to the transport subsystem where it can continue toward its destination.

The invention may be practiced with other computer system configurations including game consoles, gaming computers or computing devices, hand-held devices, microprocessor systems, microprocessor-based or programmable consumer electronics, minicomputers, mainframe computers and the like. The invention may also be practiced in distributing computing environments where tasks are performed by remote processing devices that are linked through a network. For instance, on-line gaming systems and software may also be used.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, such as the carrier network discussed above, or it may be a general purpose computer selectively activated or configured by a computer program stored in the computer. In particular, various general-purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, FLASH based memory, CD-ROMs, CD-Rs, CD-RWs, DVDs, magnetic tapes, and other optical and non-optical data storage devices. The computer readable medium can also be distributed over a network coupled computer systems so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A switch for decreasing latency associated with initiating Internet communications, the switch comprising:
a host processor;
a transport subsystem that receives incoming data and sends outgoing data; and
a semantic processor that anticipates real-time communication by analyzing the incoming data for specific types of data from a first user in order to instruct the host processor to pre-fetch data needed to initiate real-time communications with a second user, wherein pre-fetching decreases the latency associated with establishing communications between the first user and the second user.

2. A switch as in claim 1, wherein the semantic processor is configured to parse and search packet data associated with the incoming data.

3. A switch as in claim 1, wherein analyzing the incoming data further comprises,
characterizing the data for parsing;
parsing the data into segments to define tokens and groups of tokens; and
applying rules to identify tokens or groups of tokens that are indicative that a potential real-time communication will occur based on the incoming data that was analyzed by the semantic processor.

4. A switch as in claim 1, wherein the data needed to initiate a real-time communications is stored in a remote database.

5. A switch as in claim 1, wherein the host processor sends a request to pre-fetch the data needed to initiate a real-time communication as outgoing data using the transport subsystem.

6. A switch as in claim 1, wherein the pre-fetched data is returned to the switch and temporarily stored in a cache, the pre-fetched data to be used if the first user makes a request to initiate a real-time conversation with the second user before the pre-fetched data is deleted from the cache.

7. A switch as in claim 1, where the specific types of data include session initiation protocol (SIP) uniform resource identifiers (URI), secured SIP URI, and telephone uniform resource identifiers.

8. A switch as in claim 1, where the data associated with the second user includes one or more of a record from a Home Subscriber Server (HSS) in an Internet Protocol Multimedia Subsystem (IMS), other database information in non-IMS networks, presence server related access lists, and contact lists for push to talk over cellular (PoC).

9. A switch as in claim 3 wherein, accessing an online database storing at least one of an instant messaging buddy list, a VoIP phone directory, or an address book would be indicative that a potential real-time communication will occur.

10. A method for decreasing the latency associated with initiating real-time Internet communications, the method comprising:
analyzing incoming data to a transport subsystem of an Internet switch;
determining whether the incoming data contains data relevant to initiating real-time communications with a second party;
if the incoming traffic contains data relevant to initiating real-time communications, the method further including requesting a host processor of the Internet switch to query a database to pre-fetch data related to establishing real-time communication with the second party; and
storing the data associated with the second party in a cache associated with the Internet switch, wherein latency is reduced when initiating a real-time communication to the second party, as the data associated with the second party is stored within the cache.

11. A method according to claim 10, wherein analyzing incoming data includes characterizing the data for parsing and parsing the data into segments to define tokens and determining whether the incoming data contains data relevant to initiating real-time communications with a second party includes searching for tokens associated with initiating real-time communications.

12. A method according to claim 10, wherein the database queried by the host processor is located at a remote location.

13. A method according to claim 10, wherein the host processor sends a request to pre-fetch the data needed to initiate a real-time communication as outgoing data using the transport subsystem.

14. A method according to claim 10, wherein the pre-fetched data is returned to the Internet switch and temporarily stored in a cache, the pre-fetched data to be used if the first user makes a request to initiate a real-time conversation with the second user before the pre-fetched data is deleted from the cache.

15. A method according to claim 10, wherein data relevant to initiating real-time communications includes data associated with session initiation protocol (SIP) uniform resource identifiers (URI), secured SIP URI, and telephone uniform resource identifiers.

16. A method according to claim 10, wherein the data associated with the potential second parties includes the record from the Home Subscriber Server (HSS) in the Internet Protocol Multimedia Subsystem (IMS), other database information in non-IMS networks, presence server related access lists, and contact lists used for push to talk over cellular (PoC).
